(19) United States
(12) Patent Application Publication
(10) Pub. No.: US 2008/0182563 A1
(43) Pub. Date: Jul. 31, 2008

(54) Method and system for social networking over mobile devices using profiles

(76) Inventors: Theodore D. Wugofski, Fort Worth, TX (US); William Wittenberg, Lexington, MA (US); William H. Clogston, Weymouth, MA (US); Simeon Simconov, Lincoln, MA (US)

Correspondence Address: LAW OFFICE OF DAVID H. JUDSON, 15950 DALLAS PARKWAY, SUITE 225, DALLAS, TX, 75248, US

(21) Appl. No.: 11/856,192

(22) Filed: Sep. 17, 2007

Related U.S. Application Data
(60) Provisional application No. 60/844,847, filed on Sep. 15, 2006.

(51) Int. Cl. H04M 3/42

(52) U.S. Cl. 455/414.2

(57) ABSTRACT

A method and system that enables subscribers of any mobile network operator to exchange free or premium profiles, content, and services, and to receive (or share with others, such as publishers and developers) revenue resulting from transactions, preferably over a social network. In one embodiment, members of the service create one or more “profiles” that correspond to the member's persona. Preferably, profiles are built using a web browser or directly on a mobile device such as a phone. Typically, a profile comprises one or more pages containing text, images, multimedia, and advertising. In addition, profiles can include “plug-in” services developed by third parties. Members may send their profiles to other members or non-members. Similarly, anyone with a mobile phone can request the profile of a member. Multiple social networks may be aggregated on a user's mobile device. The techniques described herein facilitate the fusion of mobile application platforms and mobile social networks.

This application is based on and claims priority from Ser. No. 60/844,847, filed Sep. 15, 2006.

### BACKGROUND OF THE INVENTION

1. Technical Field

The present invention relates generally to techniques for aggregating mobile-based social networks and communities.

2. Background of the Related Art

There are hundreds of millions of domestic mobile phone accounts and nearly three (3) billion worldwide. For the younger generation everywhere, mobile phones are now the central communication device. Simultaneously, the desired form of communication among these users is evolving. Networked communities (such as MySpace, Facebook, and the like) now link people in communication webs, with hundreds of millions of people participating worldwide. Today, this communication is computer-based, and almost none of it occurs over mobile phone devices. Consumers want to extend these personal networks to mobile phones, their preferred communications tool.

### BRIEF SUMMARY OF THE INVENTION

A method and system that enables subscribers of any mobile network operator to exchange free or premium profiles, content, and services, and to receive (or share with others, such as publishers and developers) revenue resulting from transactions, preferably over a social network. In one embodiment, the subject matter may be implemented as a managed service.

Preferably, members of the service create one or more “profiles” that correspond to the member's persona. Preferably, profiles are built using a web browser or directly on a mobile device such as a phone. Typically, a profile comprises one or more pages containing text, images, multimedia, and advertising. In addition, profiles can include “plug-in” services developed by third parties. Members may send their profiles to other members or non-members. Similarly, anyone with a mobile phone can request the profile of a member. Profiles and content can be available for free, or the member can assign a premium price (i.e., other subscribers have to pay to access the profile or content). In one embodiment, when premium profiles or content are purchased, the member providing the profile or content gets a share of the transaction. Other revenue share models (such as enabling a given member to share in revenue generated from downstream distribution) may also be implemented.

The techniques described herein facilitate the fusion of mobile application platforms and mobile social networks. Unlike existing mobile application platforms, the service provides a built-in mechanism for mobile-to-mobile distribution and monetization. Unlike existing mobile social networks, the service provides software tools for innovating new services and monetizing the social network. As will be seen, the techniques described herein enable subscribers to generate and manage unique mobile personas and to allow others (including the service provider) in a value chain to monetize the result. As a consequence, mobile device users create new, dynamic social networks, and these networks are then used to promote and distribute new service features and functions.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a simplified block diagram of the basic components of a system infrastructure for use to provide social networking over mobile devices using profiles;

FIG. 2 illustrates the functional components of a server infrastructure for use in the system;

FIG. 3 illustrates the main functional modules of the system;

FIG. 4 illustrates how an end user navigates through the frames in a social network strip on a mobile device;

FIG. 5 illustrates a set of dashboard views for displaying an aggregate set of social networks; and

FIG. 6 is a more detailed set of user interface displays showing how an end user navigates through pages of multiple social networks that have been aggregated on his or her mobile device;

FIG. 7 illustrates how an operator's value-added services may be promoted or accessed on a given social network frame displayed on the device; and

FIG. 8 illustrates how operator-managed advertising may be inserted into a particular social network frame.

### DETAILED DESCRIPTION

The service described herein preferably is available to any subscriber on any mobile network that has an SMS-, browser based- or Java/BREW-enabled phone. Thus, for example, by its very nature, the SMS solution does not require a client to be distributed to the handset. When a subscriber requests a member profile, the service sends the subscriber with the requested profile as well as an invitation to join the service. If the subscriber has a handset that supports the client, a similar offer is made. Alternatively, the service is provided a client that is downloaded to the mobile device.

Thus, in a representative embodiment, subscribers join the service by creating a text message to the service or accessing a web site. Once a subscriber becomes a member, he or she can create their own personas, identify their friends, and create their own profiles. Personas are logical representations of the member. Members can create a single persona or multiple personas. Members may want to create different personas to represent their social or work lives, different business roles, or different sets of friends. Preferably, members identify their friends or create other groups of members. Members may want to create additional groups to represent different circles of friends and groups of interest. Groups can be moderated by the member, where access to the group is controlled, or the group can be open to any service member.

According to the invention, a profile is one or more “pages” that provide a presentation for a persona. The member can use the profile to provide personal information, services, or access to third party services, as will be described in more detail below. Members can use these profiles to share content with their friends, groups, or with strangers. Members can even use these profiles to make it easier for themselves to access content and services. Preferably, members create, edit, and manage their profiles using a web-based user interface or via their mobile phone. Thus, for example, members can add text, pictures, video clips, audio clips, links (referrals) to other profiles or services, and “plug-in” services to their profiles. Plug-in services make it easy for the member to add dynamic content to their profiles. These plug-ins can be as basic as text and banner advertising; as simple as interfaces to existing RSS feeds and social network content; or as interactive as voting and messaging board user interfaces. Preferably, the service provides tools to enable third parties to create their own plug-in services or integrate with their own web services. As will be described below, preferably members can send their profiles to other members or non-members using a web-based user interface or via their mobile phone. In addition, subscribers can request a member's profile using a web-based user interface or via their mobile phone—even if the subscriber is not a member of the service. When a member creates a profile, he or she can specify if the profile is available to any and all mobile subscribers or whether the profile is limited to a group or set of friends. The member can also be notified if someone without access is requesting their profile and grant access as appropriate.

Profiles, referral links, and plug-in services can be available for free, or the member can assign a usage price. When a subscriber accesses the premium service, he or she will be charged the assigned amount—typically showing up as a premium on their mobile phone bill. Typically, there are two types of referral links: “subscriber pays” and “sponsor pays.” Premium plug-ins may be made available to members on a subscription or pay-per-use basis. With subscription plug-in services, the member can use the plug-in service within their profile for the term of the subscription. With pay-per-use plug-in services, the member pays for the service each time the service is used within predefined constraints (for example, the subscriber will be charged each time it is used, but no more than once a week). Preferably, revenue associated with premium plug-ins is shared by the service and the plug-in service's publisher. Preferably, members have an online (e.g., PayPal or a comparable account) to benefit from these transactions. If the member does not have an appropriate account, the service may retain their share.

As noted above, the techniques described herein enable subscribers to generate and manage unique mobile personas and to allow others (including the service provider) in a value chain to monetize the result. As a consequence, mobile device users create and/or leverage new social networks (over mobile devices), and these networks are then used to promote and distribute new service features, functions and business processes. Some of these service features, functions and processes are described below, by way of example only.

### Mobile Personas and Profiles

In this embodiment, a system is provided to enable members to create multiple personas, where each persona can have one or more profiles containing text, images, multimedia, interactive content, and plug-ins. According to this embodiment, the system provides the ability to associate profiles with groups. Members can have one profile that is automatically shown to one set of subscribers and another profile that is automatically shown to a different set of subscribers. The appropriate profile preferably is determined by a unique identifier (such as a user name or mobile phone number) associated with the subscriber. The system preferably provides the subscriber with the ability to activate different personas and have rules for when a profile is active. Thus, e.g., a member might choose to activate his or her “nightclubbing” profile or their “in school” profile manually, or set rules such as “time of day” or “within 100 meters.” In this embodiment, the system may also provide the ability for a member to ask his or her friends if they know a subscriber identified by a profile, as well as the ability for that subscriber to control distribution of his or her profile to unknown parties manually or based on subscriber characteristics (e.g., limiting distribution of a profile to underage subscribers or those that do not belong in a group). The ability to share profiles with other subscribers or members when “offline” or when “connected” to the third party (i.e., sending a profile to the person you are talking to). Preferably, members can share their profiles with specific subscribers, with a group, or with members that share certain characteristics (such as common profile attributes, areas of interests, tags, or location). Of course, the above are merely representative examples.

### Mobile Profiles and Plug-in Services

In this embodiment, mobile profiles contain server-side or client-side plug-ins (widgets). According to this feature, these plug-in services generate a presentation within the profile and allow the subscriber to interact with the profile. Thus, for example, they may include server-side widgets that dynamically create a presentation when the profile is sent to a mobile subscriber. These presentations can be based on service information as well as characteristics of the target subscriber such as their membership in a group, location, and time-of-day. Server-side presentations can include interactive components such as hyperlinks, voting controls, and edit fields. Alternatively, client-side widgets are used to dynamically create a presentation when the profile is accessed by the mobile subscriber. As with the server-side widgets, these presentations can be based on service information as well as characteristics of the target subscriber such as their membership in a group, location, and time-of-day. Client-side presentations likewise can include interactive components such as hyperlinks, voting controls, and edit fields. Among other advantages, plug-in services can generate referral networks. When a subscriber sees or interacts with a member's plug-in, a referral network is created. Further, plug-in services may have access controls limiting their distribution or access to specific groups and their ability to be forwarded to other subscribers.

### Monetizing Mobile Profiles

According to this embodiment, mobile profiles and profile content are monetized and participants in the value chain share revenue. In particular, members create premium mobile profiles in which a subscriber is charged for accessing that profile. The member receives a share of that charge. Members may have premium referrals in their mobile profiles. When a subscriber follows a “subscriber pays” referral link, the revenue associated with that event is shared by the profile's member, a service provider, and the destination profile. When a subscriber follows a “sponsor pays” referral link, the revenue associated with that event is shared by the profile's member and the service provider (in some cases, the subscriber may also benefit). Preferably, members can buy premium plug-ins on a one-time, subscription, or pay-per-use basis. Recurring costs can be constrained (e.g., member pays per-use but does not have to pay more than once a week). The plug-in publisher receives a share of that charge. Premium plug-ins can also generate a charging event that occurs when the plug-in is used by a subscriber (e.g., when he or she votes, or downloads a ring tone). As with referral links, there may be “subscriber pays” or “sponsor pays” premium plug-ins. Also, members can put their own advertising in their mobile profiles or select from an inventory of sponsors. As a result, members can receive a share of advertising revenue.

### Event-Driven Display of Mobile Profiles

In this embodiment, mobile profiles are displayed in response to an event, such as receiving a text or multimedia message, an incoming voice call, or dialing a third party, or getting within 100 meters of the profile's owner or a specified location.

### Automatic Generation of Service Menus From Mobile Profiles

In this embodiment, mobile profiles provide menus for other services or pages offered by a member, and preferably the menu is weighted. Thus, for example, service menus can be built based on the number of times all subscribers access a particular feature within a member's profile. Alternatively, service menus can be personalized based on characteristics about the subscriber and characteristics of other subscribers accessing a member's profile or referring to a profile.

### Providing Feedback to a Mobile Profile

In this embodiment, subscribers provide feedback to a mobile profile and that feedback is available to other subscribers with access to that mobile profile. Thus, for example, members can use rules to tailor how much feedback is available to subscriber's accessing their mobile profile and whether feedback is available to all subscribers or limited to particular groups. Preferably, subscriber's can “tag” a member's profile. These tags are used when a subscriber is searching the service for profiles of interest. Preferably, members manage whether tagging is available to all subscribers or limited to particular groups.

### Monetizing Distribution of a Mobile Client From a Mobile Profile

In this embodiment, members are compensated based on their ability to distribute client software to another subscriber.

### Updating Mobile Profiles Based on Network Characteristics and User Preferences

In this embodiment, a member has a set of stored subscriber profiles that are autonomously updated depending on characteristics of the current network connection or user preferences. Thus, when a network is available, these profiles can be autonomously updated depending on bandwidth, cost, and battery life. For example, all profiles are updated when connected to a fast cheap network like WiMax, but only heavily used profiles are updated when connected to slow expensive networks like GPRS. Of course, these are merely representative examples.

### Automatically Generating Profile Content Based on Groups

In this embodiment, a member has a profile containing content that is automatically created by combining elements from other members' profiles. For example, a member has a profile page containing the most popular music artists featured on their friends' profiles, or the most popular plug-in services accessed on their friends' profiles. As another example, according to this embodiment a member receive a “cliff notes” version of what happened on his or hers friends' social network sites or mobile profiles. This digest may be delivered to the member's mobile phone or viewed via the Web.

### Buying Content From a Mobile Phone Based on Profiles

In this embodiment, a member buys music (or other content) based on another member's profile and then that music is downloaded to either the mobile phone or another device (such as a personal computer). Preferably, the “seller” shares in a purchase transaction, and the price may vary depending on the type of distribution.

### Aggregating Multiple Social Networks Into a Single Profile

In this embodiment, a member specifies his or her profiles in multiple social network services and the system aggregates content from those services into a single mobile profile.

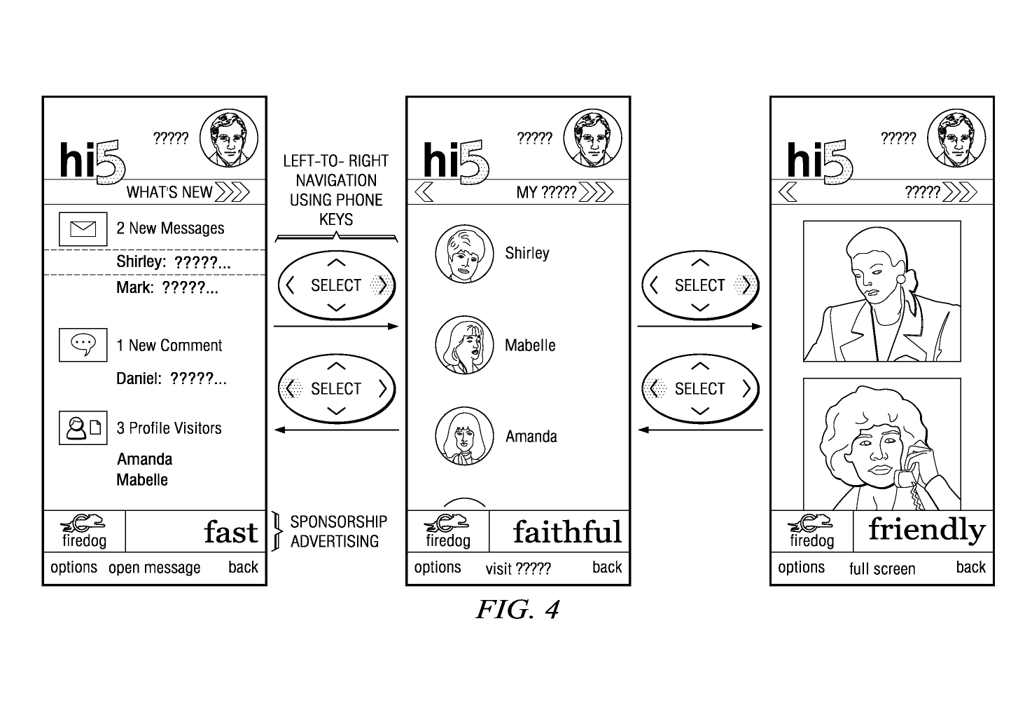

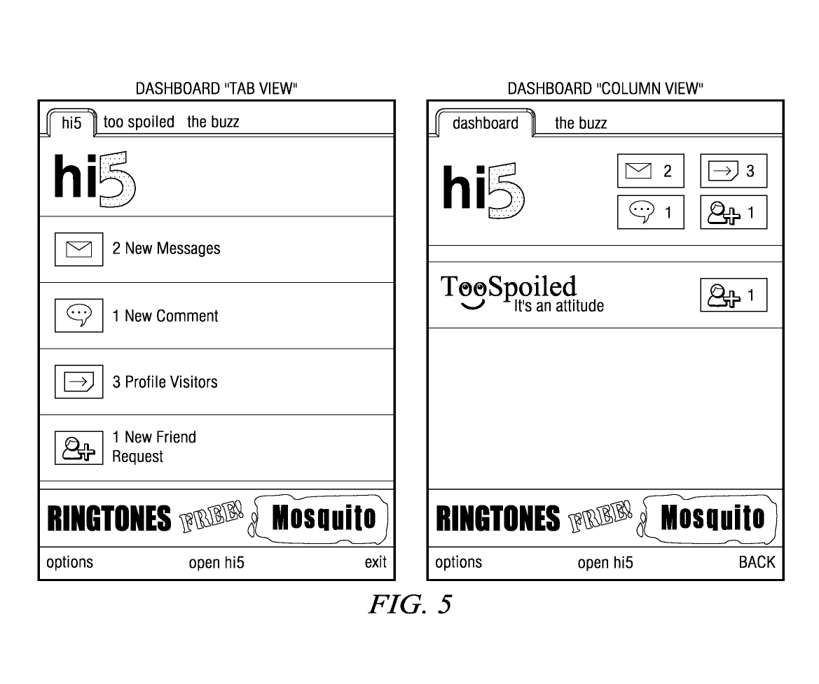

A member accesses the multiple social networks using a social networking dashboard (on his or her mobile device) that lets the user get a simple and quick aggregated view of what is going on in their communities. Preferably, the mobile device user interface provides access to each social network as a set of “frames” in a “strip,” and the user navigates between the frames in a strip using the device's navigation (e.g., the left and right) keys. FIG. 4 illustrates this technique. The service may provide a set of generic frame and strip templates that correspond to common features of social networks (e.g., what's new, messages, my friends, popular photos, new members, friend requests, member photos, and the like). FIG. 5 illustrates a representative mobile device social network dashboard. Preferably, the user can choose between several dashboard views, with the first view (on the left) showing each individual social network and community using a “tab” paradigm. The second view (on the right) shows each social network on a single screen, e.g., in a single column. In both user experiences, the consumer can quickly determine whether something new or fresh has happened in one of their communities and act accordingly.

FIG. 5 also illustrates that the dashboard may include a sharing link (referred to here in this example as “the buzz”). This link is a way for consumers to share their favorite content and services with their friends and a way for consumers to find information from others. When this link is selected, the resulting page (e.g., another frame) may contain new “finds” from friends across the consumer's social networks and communities. By selecting one of these “finds,” the user may then be navigated to another social network, even if the user is not currently a member of that community. He or she can then sign up to that community. Similarly, if “the buzz” points to premium content, the user can buy that content without having to find the content buried in an on-deck or off-deck portal. This facilitates discovery and distribution of new content among users.

Preferably, once a consumer has signed up to a new social network, that social network is automatically imported into the service as just another strip.

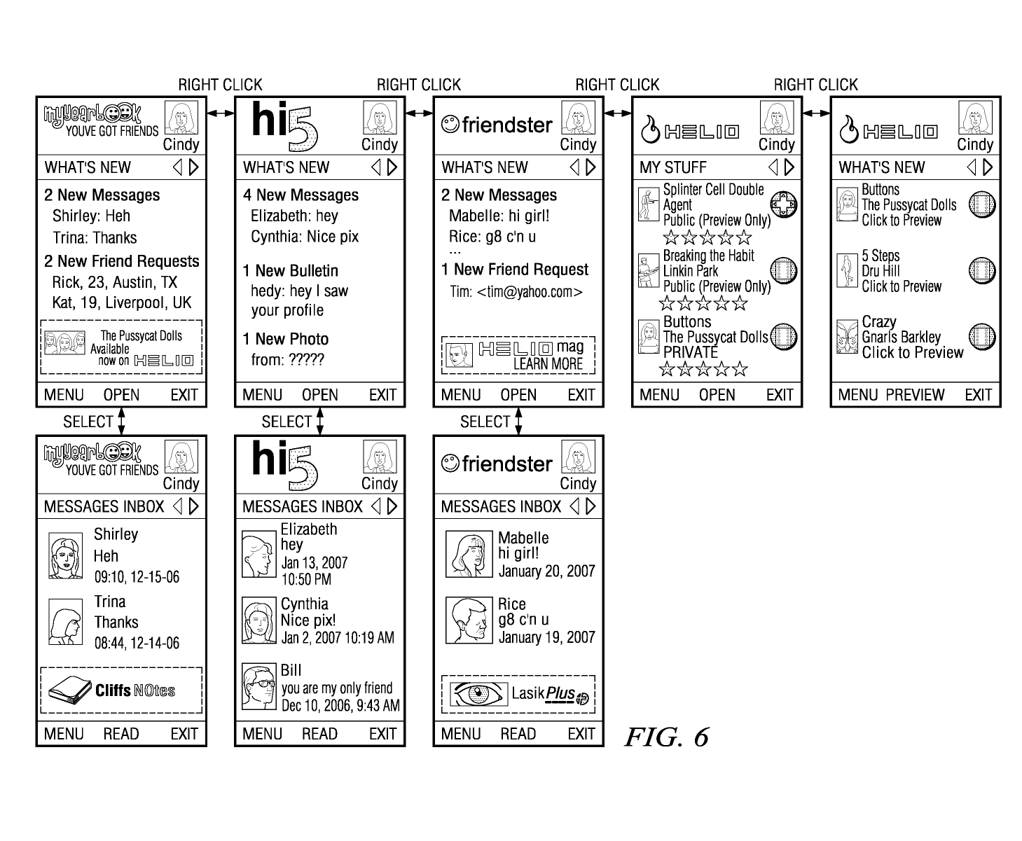

FIG. 6 illustrates how a user can easily navigate through the aggregated multiple social networks. In this embodiment, as the user right clicks, another social network (or another frame in a currently displayed network) in the aggregate set is displayed. An “open” link is used to navigate within a particular frame.

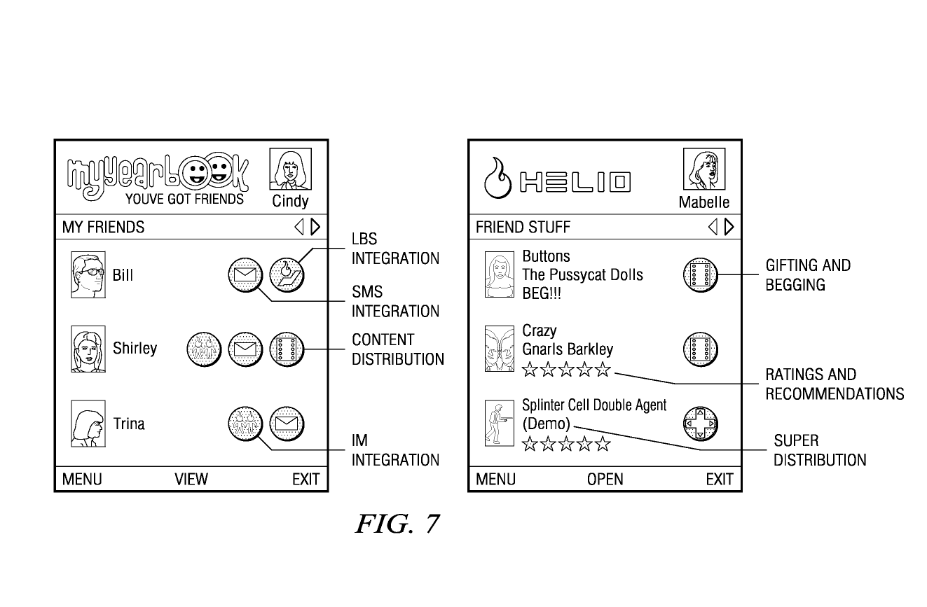

FIG. 7 illustrates how an operator's value-added services may be promoted or accessed on a given social network frame displayed on the device.

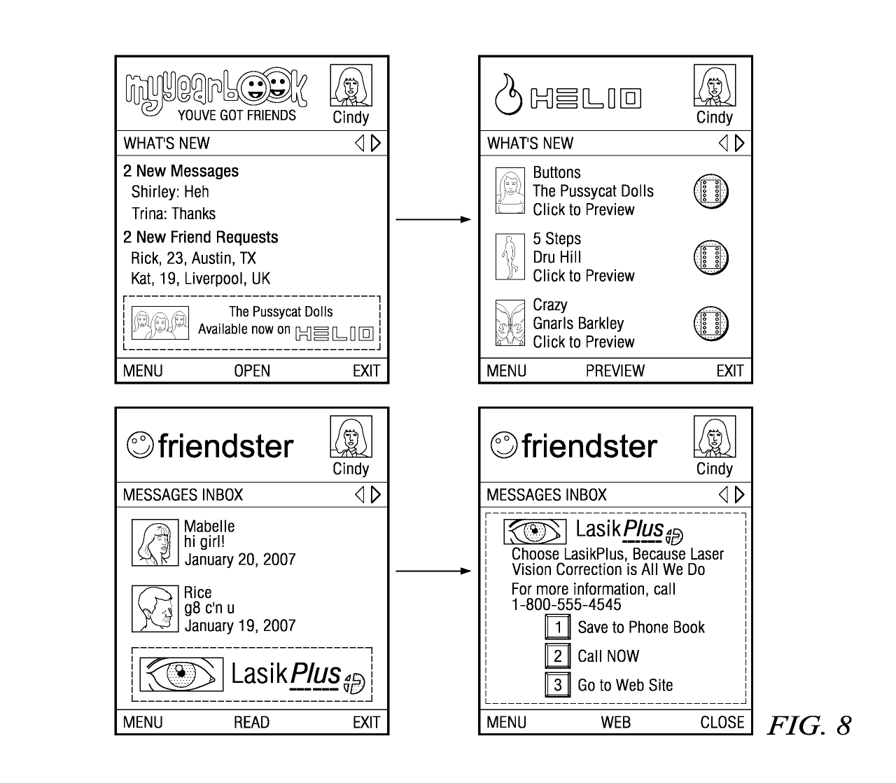

FIG. 8 illustrates how operator-managed advertising may be inserted into a particular social network frame.

### Aggregating Content Portals and Portal Content

In this embodiment, existing “on deck” and “off deck” content, normally accessible via a mobile phone browser, is discoverable, distributable, and is monetized.

### Distributing Adult-Oriented Services on Mobile Phones Using Profiles

In this embodiment, adult-oriented services are delivered on a mobile social networking system in association with mobile profiles. The system includes conventional access control, content protection, and content monetization according to an affiliated business model.

### Ratings and Recommendations Engine on Mobile Profiles and Content

In this embodiment, members explicitly rate or recommend mobile profiles and mobile profile content. Thus, for example, members can query for mobile profiles and content based on these ratings and recommendations and receive appropriate responses.

### Mobile Coupons in a Mobile Social Networking Service Having Profiles

In this embodiment, coupons are provided on mobile phones. A member gets compensated for distributing that coupon, and the value of that coupon may increase as it is forwarded or used by more people in the member's network. Once again, this feature preferably is enabled using mobile profiles.

### Personal Content Downloads in Association With Mobile Profiles

In this embodiment, content is stored on a personal computer and made available for download onto a mobile phone or other wireless device in association with a mobile profile. Preferably, this content is distributed to other subscribers at a premium with revenue shared with the originator and those in the distribution chain.

### Affiliate Marketing of Mobile Profiles

In this embodiment, members make money by marketing profiles or plug-in services. For example, a member can receive a bounty when a subscriber follows the referral to 3^{rd} party's mobile profile; the member can make a percentage of subscription revenues based on the number of referrals that they drive to the profile; the member can earn a bounty when a subscriber follows the referral and actually subscribes to the profile; and the member can earn a percentage as broker for the profile. These are merely representative examples. In any event, the third party profile can be a commercial entity (such as a dating service), or it can be person who is trying to increase the size of his or her personal network.

### Finding a Friend Using Mobile Profiles

In this embodiment, a member locates a mobile profile in which there are common interests (for example, profile information, tags, friends-of-friends, or services). One way of implementing this feature is to have a member create his or her own “survey”, distribute that survey to other members, and, based on the results, find members of interest. This process may be monetized where the service provider and recipient receives revenue for a connection.

### Managing Location Using Mobile Profiles

In this embodiment, techniques are provided for associating location with personas and mobile profiles, finding members who are nearby or at a particular location, and finding friends-of-friends who are nearby or at a particular location. Thus, for example, a friend can easily get driving or walking directions to another friend or send messages or content to nearby members while privacy is retained.

### Pricing Based on Personal Network Size

In this embodiment, the cost of using the service or aspects of the service varies depending on the number of subscribers a member is “connected to” and the number of subscribers that they are “connected to”. This feature is also profile-driven.

### Contests Using Mobile Profiles

In this embodiment, contests are promoted in a mobile profile, members participate in those contests, and members benefit by promoting the contest to other members.

### Sharing Mobile Profiles

In this embodiment, free and premium profiles are shared with friends. Preferably, a member is compensated for sharing that profile or being the first to include a plug-in service within his or her profile (i.e., exposing something new to their social network). This is especially useful for commercial profiles, such as a profile promoting a movie or television program.

### Donating and Gifting Between Mobile Profiles

In this embodiment, a member donates or gifts to another member access to a premium profile or plug-in.

### Generating a Mobile Profile Based on Search Results

In this embodiment, a member searches for another member and, if a profile is not found, one is generated by searching the Internet and other social networking services.

### Brokering the Purchase and Trading of Mobile Profiles

In this embodiment, a member seeks to purchases a name from another member, even if the former does not have direct contact with the latter member. Preferably, a service provider receives a commission for a successful transaction of this type.

### Requesting Multi-Faceted Mobile Profiles

In this embodiment, mobile profiles have different views depending on who is asking for the profile, when it is being requested, or the location of the person or entity that is asking.

### Additional Background on Mobile Devices and Computing Environments

As previously noted, the present invention assumes that members use mobile devices. Such devices include any wireless client device, e.g., a cellphone, pager, a personal digital assistant (PDA, e.g., with GPRS NIC), a mobile computer with a smartphone client, or the like. A typical mobile device is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. A given mobile device communicates with another such device via many different types of message transfer techniques, including SMS (short message service), enhanced SMS (EMS), multi-media message (MMS), email WAP, paging, or other known or later-developed wireless data formats.

The present invention may be implemented as service by an operator using a set of one or more computing-related entities (systems, machines, processes, programs, libraries, functions, or the like) that together facilitate or provide the inventive functionality. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-routable Internet, a corporate intranet, a private network, or any combination thereof, depending on the desired implementation environment.

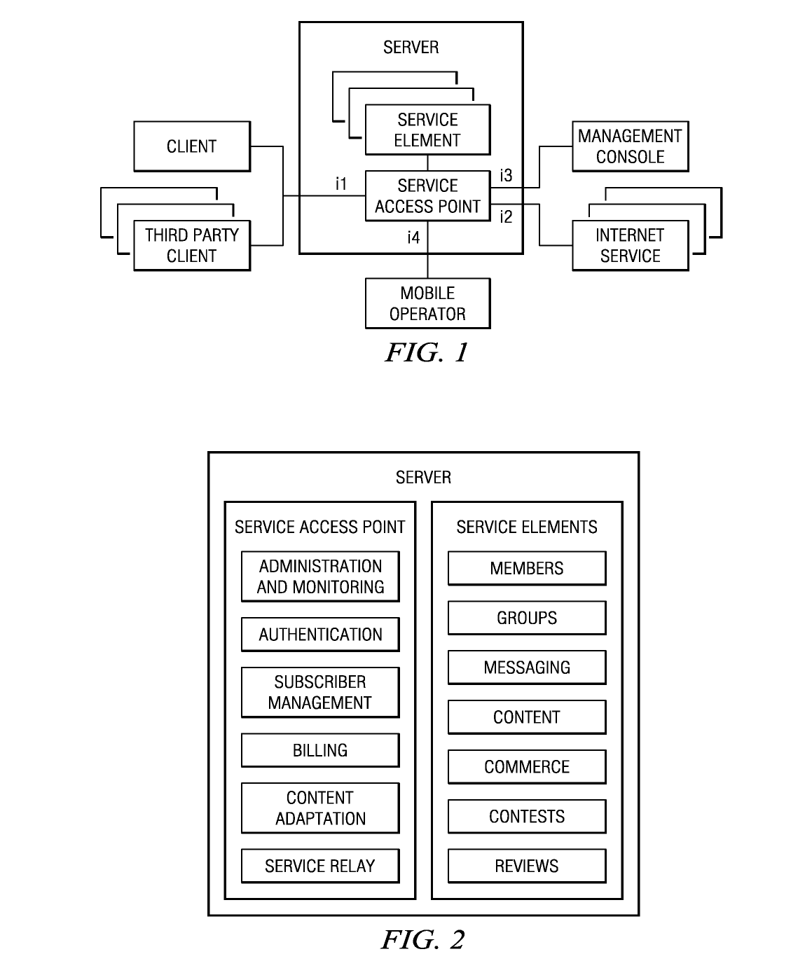

The following provides additional details regarding a preferred architecture of the service, and its relationship to mobile networks and the Internet. As seen in FIG. 1, the architecture is a client-server architecture where the server is managed by a service provider and the clients are mobile devices, personal computers, or third party Internet services.

### Functional Entities and Interfaces

### 1.1.1 Server

The Server (which may be more than one machine or process) is the central point of the architecture. As illustrated above, the Server consists of Application Service Elements that are accessible via the Service Access Point. The Application Service Elements are:
Member Management
Group Management
Messaging
Content Management
Commerce
Contest Management
Review Management

The Service Access Point (see FIG. 2) preferably comprises six (6) basic elements in addition to a set of common functions such as database management:
Administration & Monitoring
Authentication & Authorization
Subscriber Management
Billing & Charge Authorization
Content Adaptation
Service Relay

The Server preferably is a Java-based high performance, scalable, secure and carrier-grad server optimized to cost effectively support small applications on hundreds of devices used by large numbers of subscribers. The Server provides two-way, real-time, interaction capabilities between the server and multiple clients for highly interactive and dynamic data-driven applications. It integrates with other servers through standard Web services interfaces to enable real-time commerce and database transactions. Interfaces are provided for integrating with third party billing systems, advertising management systems, and content adaptation. Optional modules are provided for accessing a mobile network operator's location-based information, presence information, personalization servers, content management systems, and other value-add services.

1.1.2 Member Management Service Element

The Member Management Service Element is responsible for managing mobile subscribers' access to the Internet service.

1.1.3 Group Management Service Element

The Group Service Element is responsible for managing the Internet service's member groups accessible to mobile subscribers.

1.1.4 Messaging Service Element

The Messaging Service Element is responsible for managing the person-to-person, person-to-group, and service-to-person messaging between the mobile subscriber and the Internet service.

1.1.5 Content Management Service Element

The Content Service Element is responsible for managing content associated with member groups and subscribers using the Internet service.

1.1.6 Commerce Service Element

The Commerce Service Element is responsible for managing transactions that result in a charge assigned to a mobile subscriber or the transfer of credits between members.

1.1.7 Contest Management Service Element

The Contest Management Service Element is responsible for managing contests, voting, polling, and other such activities supported by the Internet service.

1.1.8 Review Management Service Element

The Review Management Service Element is responsible for managing reviews of products, media, restaurants, and other such objects supported by the Internet service.

1.1.9 Service Access Point

The Service Access Point serves as the interface between the Server and the environment. Preferably, it has interfaces to clients, 3^{rd} party clients, Internet services, and a mobile network operator.

The Service Access Point preferably exposes four interfaces:
A first interface defines the protocols between clients and the Service Access Point. In addition, the first interface specifies the presentation language and multimedia formats supported by the Server.
A second interface defines the protocols and application programming interfaces (APIs) between Internet services (such as a social networking service) and the Service Access Point.
A third interface defines the protocol and APIs between the Service Access Point and web-based management consoles, data mining consoles, and reporting facilities.
A fourth interface defines the protocol between the Service Access Point and mobile network operator (including the operator's instant messaging and presence services, location-based services, and core network services).

As noted above, the service can be distributed via the Web, mobile-to-mobile, or pre-installed by the mobile phone equipment manufacturer. In one embodiment, the service provider provides a simple web control that can be inserted into any web site, including a third party social network. From that control, end-users can request a profile be sent to their phone or subscribe to the service.

The underlying service provider enables mobile operators to become participating service providers. This enables the participating service provider to provide the functionality to its mobile subscribers. Once a mobile operator creates an account, the operator can define, provision, and manage mobile services. The underlying service provider provides a web console to enable provisioning of the services. As noted above, in an illustrated embodiment, the mobile operator enables its subscribers to create “profile-oriented” communities, which are social networks where an individual is at the center of community interaction. Typically, an individual has a profile or web page that other people in the network interact with, posting messages, commenting on music, or the like. If desired, the mobile operator may also enable blackboard-oriented communities, which are social networks where shared spaces are at the center of community interaction. Typically, these are discussion boards or content repositories that people in the network interact with, posting messages, commenting on videos, or the like. When the developer clones a service based on one of these generic communities, they automatically generate a set of user interfaces pre-connected in a manner appropriate to the nature of the community. Each user interface is called a “card” and a collection of cards is called a “deck.” Thus, for example, when a developer clones a profile-oriented community, preferably the following cards are generated: home card, member login card, feature menu card, feature card, member browser card, member profile card, promotion card, message creation card. After a developer has created a new service by cloning an existing one, the management consoles presents a service definition, a deck of cards that describe the user interface, and resources used by the deck of cards (e.g., pictures, text, databases, and the like). Cards represent logical user interfaces. In general, one card is implemented as one “screen” of user interface objects on a device. Each card exposes a set of properties that can be specified or tailored by the developer. These include connections (links from one card to another), parameters (values that affect the behavior of the card), static resources (text or multimedia that does not change depending on the current user or when the service is being used), dynamic resources (text or multimedia that may change depending on the current user or when the service is being used), and events (values that get set when specific activities occur on the user interface). The card's implementation (which is specific to the target device's presentation engine technology) uses the value of these properties to build an appropriate presentation. After a developer has specified the properties and identified a set of target devices, they can specify how to deploy the service, how to set up charging and billing mechanisms, how to connect to existing operator services, and the like.

Using this infrastructure, communities are insulated from the technical difficulties of mobilization because the underlying service provider addresses cross-carrier interoperability issues, cross-handset issues, bandwidth limitations, and device display constraints. In addition, the underlying service provider relieves communities of the difficulties and costs associated with developing business relationships with each carrier, which would otherwise be quite burdensome given that social networks know no geographical boundaries.

The underlying service provider provides consumers with (preferably) advertising-sponsored access to their social networks and communities through their mobile phones. In return, these social networks are provided with a fast (potentially) no- or low-cost means of mobilizing their communities and in the process capturing new revenue streams. Mobile network operators can leverage the resulting mobile networks to increase the discovery, distribution and monetization of their existing and new content and services. In one embodiment, communities pay the underlying service provider in the form of shared advertising revenue.

The underlying service provider aggregates multiple social networks and communities, making it simple for carriers to on-board the long tail of many social networks, as opposed to a small few. The underlying provider provides an improved consumer experience (in part by allowing multiple social networks to be aggregated on the user's device) that helps the carrier sell new and existing products and services. The user experience enables consumers to discover new and existing services via their personal networks.

The system provides a comprehensive platform for developing and deploying highly effective mobile device based community applications. The benefits to consumers, communities, and carriers are far reaching. Communities obtain, among other advantages, fast time-to-market, reduced or no cost to mobilize their functionality and content, new mobile revenue streams (via advertising and premium services), broad reach and viral distribution, and the like. End user consumers obtain, among other advantages, the ability to take their social networks and relevant communities with them, the ability to discover new and interesting content from their friends, the ability obtain easy access to checking updates, linking to friends, and sharing profiles, and the like. Mobile carriers obtain, among other advantages, increased sell-through of profitable content and services, on-boarding of large numbers of social networks and communities, and the like.

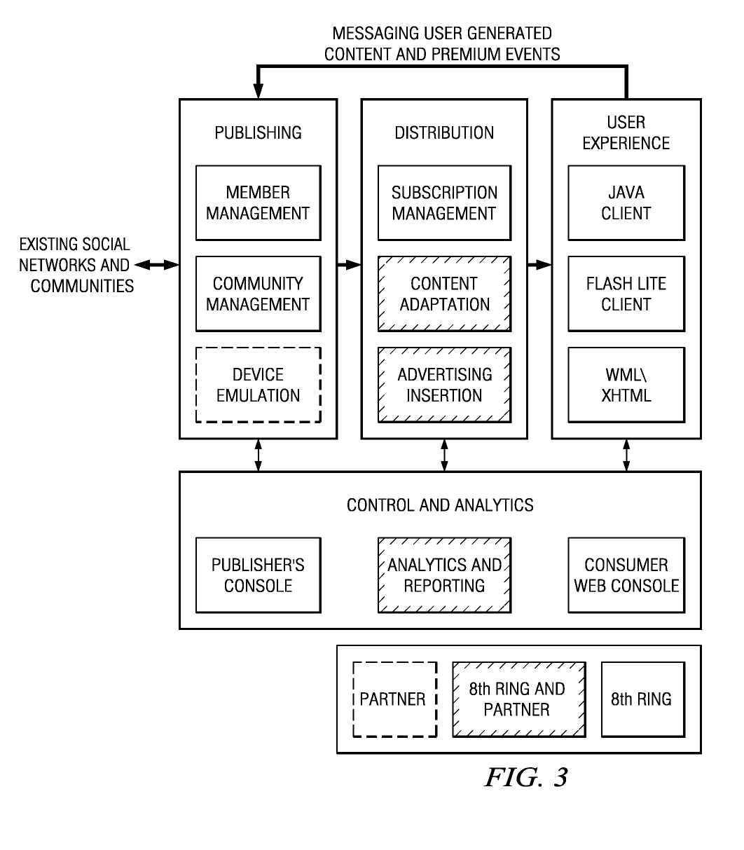

FIG. 3 shows an architecture in which the techniques described herein may be implemented. The publishing functions provide existing social networks and communities with tools to build user experiences that are supported across a wide range of mobile phones. The distribution functions manage the subscriber's subscriptions to different services, adapt those services to the capabilities of the mobile phones, and insert relevant advertising into the user experience. The user experience functions present the service to the subscriber and handle any interaction. There may be several types of client technologies implemented: a browser-based solution (based on WML/XHTML), a downloadable Java client, and a Flash-lite client to address BREW devices. In one embodiment, a server-side application includes a mobile phone browser proxy that makes it easy for subscribers to access the service via their mobile phone browser. This server-side application interacts with the system Server, translating results into XHTML and WML as appropriate.

As also seen in FIG. 3, the system may include one or more web-based management consoles that support the consumer, publisher and operator. The consumer console enables the consumer to manage his or her account, manage their social networks and communities, and personalize their user experience. The publisher console enables the service owner to make their services available to consumers, manage and target advertising inventory, and perform a variety of usage measurements and analysis. The operator console enables the mobile system operator to configure and manage the overall service (for its subscribers) and its usage of software and hardware resources.

Using the system, providers can focus on mobilizing social networks and communities, and then connect that aggregated set of networks to content management systems. Once deployed, consumers can access their favorite communities, browse friends' profiles, search for and buy new content, subscribe to new services, and send their profiles and favorites to other subscribers.

End users can mash-up their own user interface elements (widgets) into unique personalized profiles, share these widgets and profiles with friends, and discover, capture, and buy new widgets and profiles.

While given components of the system have been described separately, one of ordinary skill will appreciate that some of the functions may be combined or shared in given instructions, program sequences, code portions, and the like.

Having described our invention, what we now claim is as follows.

1. A method, operative in a mobile network, comprising:
having a first mobile device user create a mobile device user profile; and
enabling a second mobile device user access to the mobile device user profile of the first mobile device user to create a mobile social network among the first and second mobile device users.

2. The method as described in claim 1 wherein the mobile device user profile enables the first mobile device user to share one of: information about the first mobile device user, one or more links to other profiles or services, and one or more plug-in services.

3. The method as described in claim 2 wherein the one or more plug-in services comprise a plug-in that generates a presentation within the mobile device user profile.

4. The method as described in claim 3 further including enabling either the first mobile device user or the second mobile device user to interact with the mobile device user profile using the presentation.

5. The method as described in claim 1 wherein the second mobile device user is charged a fee to access the mobile device user profile of the first mobile device user.

6. The method as described in claim 1 wherein the second mobile user obtains access to the mobile device user profile upon occurrence of an event.

7. The method as described in claim 1 further including generating a service menu in association with the mobile device user profile.

8. The method as described in claim 1 wherein the second mobile device user provides information that is included in the mobile device user profile of the first mobile device user.

9. The method as described in claim 1 further including updating the mobile device user profile.

10. The method as described in claim 1 wherein the mobile device user profile is associated with one or more online social networks.

11. The method as described in claim 10 wherein the one or more online social networks are aggregated for display in association with the mobile device user profile.

12. The method as described in claim 1 wherein the first mobile device user and the second mobile device user are subscribers to a particular mobile service operator network.

13. The method as described in claim 1 wherein the first mobile device user and the second mobile device user are subscribers to different mobile service operator networks.

14. A method, operative in a mobile network, comprising:
maintaining a profile for each of plurality of mobile device users, wherein the profile of a particular mobile device user includes information identifying each of a set of two or more social networks to which the mobile device user is associated, wherein the profile aggregates the two or more social networks; and
serving data to a mobile device of a particular mobile device user, the data enabling display on a display interface of the mobile device of the user's two or more social networks.

15. The method as described in claim 14 further including updating the profile to include an additional social network to which the mobile device user becomes associated.

16. The method as described in claim 14 wherein each of the two or more social networks are accessible via interaction with the display interface.

17. The method as described in claim 16 wherein the two or more social networks are accessible from a single display page.
